(19) United States
(12) Patent Application Publication
(10) Pub. No.: US 2026/0350666 A1
(43) Pub. Date: Nov. 5, 2026

(54) Dynamic Sealed Offer Generation and Fair Market Pricing Engine for Platform-Controlled Execution

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/335,745

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.

(51) Int. Cl. G06Q 30/0601; G06Q 10/083

(52) U.S. Cl. CPC G06Q 30/0611; G06Q 10/083

(57) ABSTRACT

A system for sealed, platform-controlled offer generation based on verified buyer input, escrow verification, and license-cleared vendor eligibility. Vendors cannot present pricing outside platform rails. Offers are sealed, auditable, jurisdictionally compliant, and aligned to buyer-specific metadata. Unauthorized pricing injection is blocked.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to pricing logic systems for seller-side fulfillment and sealed offer generation within platform-bound execution environments.

### BACKGROUND OF THE INVENTION

Conventional platforms permit sellers to generate offers without platform-regulated pricing, leading to price gouging, inconsistent delivery terms, and unverified vendor matches.

Additionally, seller pricing is often calculated independently of buyer context, resulting in imbalanced offers and fulfillment failures.

There is a need for sealed, platform-controlled offer generation logic that ties pricing to verified buyer triggers and trust-gated vendor eligibility.

### SUMMARY OF THE INVENTION

This continuation provides a sealed offer generation system where sellers cannot independently present pricing or fulfillment terms unless cleared through platform-controlled logic.

The system enables dynamic pricing aligned with verified buyer metadata, market benchmarks, escrow tier, and jurisdictional constraints.

All pricing is sealed, auditable, and bound to trust-verified vendor triggers that eliminate manipulation or bypass.

### DETAILED DESCRIPTION OF THE INVENTION

Upon buyer input, the system extracts metadata including location, urgency, product or service need, escrow credentials, and compliance region.

A sealed pricing engine compares real-time benchmark rates, risk tolerance, regulatory caps, and vendor class.

Only vendors that pass license verification and escrow clearance are allowed to generate an offer.

All offers are cryptographically sealed, logged, and time-stamped for audit enforcement.

Sellers cannot modify pricing outside the platform or via external APIs.

Offer validity is tied to expiration parameters and buyer-side response metrics.

Dynamic pricing adjustments occur based on trust level, prior fraud flags, or competitive fulfillment windows.

Sealed pricing offers are ranked and presented only after escrow commitment is confirmed.

Platform disallows any seller from presenting pricing without platform-sealed generation.

What is claimed is:

1. A sealed offer generation system comprising:
a buyer input module;
a platform-based pricing engine;
a vendor eligibility checker;
and a fulfillment gate that presents offers only from escrow-cleared, trust-verified vendors.

2. The system of claim 1, wherein pricing is computed based on buyer location, service urgency, escrow tier, and regulatory pricing benchmarks.

3. A method comprising:
receiving a fulfillment request;
extracting buyer metadata;
computing a sealed offer using platform logic;
and presenting offer options only if vendor trust and escrow thresholds are met.

4. The system of claim 1, wherein all offers are cryptographically sealed and logged for audit traceability.

5. The method of claim 3, wherein vendors without current escrow deposits or platform licenses are denied access to pricing tools.

6. A pricing engine comprising:
market benchmarking data, buyer-derived variables, vendor class eligibility, and compliance filters.

7. The system of claim 1, wherein sellers are prohibited from injecting pricing via non-platform APIs or third-party tools.

8. The method of claim 3, wherein sealed offers include expiration timers and buyer responsiveness scoring.

9. A fulfillment logic control mechanism that compares vendor offer data to buyer escrow standing and geographic permissions.

10. The system of claim 1, wherein unauthorized vendors attempting to present pricing are flagged for enforcement.

11. A cryptographic sealing mechanism comprising:
timestamping, vendor ID linkage, escrow tag, and benchmark anchoring.

12. A vendor ranking module that limits offer generation to top-tier license-cleared vendors within regulatory range.

13. A buyer-side audit dashboard showing sealed offer comparisons, license tier, and escrow compliance of each vendor.

14. The method of claim 3, wherein platform-modified pricing is permitted based on fraud detection or compliance override logic.

15. A system of claim 1, wherein vendor pricing attempts outside sealed rails are rejected at gateway level.

16. A system for cross-jurisdictional pricing compliance, locking offer logic to geo-restricted caps.

17. The method of claim 3, wherein buyer urgency modifies offer exposure time and vendor response allowance.

18. A sealed pricing protocol comprising:
buyer fulfillment triggers, escrow verification, license confirmation, and sealed vendor response.

19. The method of claim 3, wherein the platform disables vendor execution if pricing data is noncompliant with sealed benchmarks.

20. The system of claim 1, wherein offer logs are stored in a trust-enforced database with visual comparison tools.

21. The system of claim 1, wherein metadata attached to the buyer input is parsed to enforce jurisdictional compliance prior to escrow clearance.
